(19) United States
(12) Patent Application Publication
(10) Pub. No.: US 2008/0146324 A1
(43) Pub. Date: Jun. 19, 2008

(54) METHOD AND SYSTEM FOR CHANGING GAMING MACHINE DISPLAY ELEMENTS TO COMPLEMENT GAME OUTCOME

(76) Inventor: Philip Jeffrey Anderson, Las Vegas, NV (US)

Correspondence Address: MCANDREWS HELD & MALLOY, LTD, 500 WEST MADISON STREET, SUITE 3400, CHICAGO, IL, 60661, US

(21) Appl. No.: 11/952,797

(22) Filed: Dec. 7, 2007

Related U.S. Application Data
(60) Provisional application No. 60/869,033, filed on Dec. 7, 2006.

(51) Int. Cl. A63F 13/00

(52) U.S. Cl. 463/25

(57) ABSTRACT

A gaming device and method that can determine and display at least one or more complementary colors or images in non-game symbol areas of the display of the gaming device such as in borders, as a background, or “wallpaper” color or image, based on the characteristics of the game symbols selected, displayed, or to be displayed.

### CROSS-REFERENCE TO RELATED APPLICATION

The present application claims priority to U.S. Provisional Patent Application No. 60/869,033 filed on Dec. 7, 2006, entitled “METHOD AND. SYSTEM FOR CHANGING GAMING MACHINE DISPLAY ELEMENTS TO COMPLEMENT GAME OUTCOME,” which is herein incorporated by reference in its entirety.

### FIELD OF THE INVENTION

The present invention relates to a gaming machine, and more particularly to a method and apparatus for changing color or non-game symbol images in association with the particular outcome of a gaming machine to complement the game outcomes.

### BACKGROUND OF THE INVENTION

Slot machines are popular gaming devices found in casinos throughout the world. The entertainment value of such machines is related in part to the perceived likelihood of winning money. It would be highly desirable to vary or accelerate this anticipation factor to increase the value of the slot machine. Besides a perceived likelihood of winning, a number of factors, including visual effects created by the gaming machine, serve to increase the excitement level of the player. There is a need for new gaming machines in the gaming industry which will enhance the entertainment value and excitement level of slot machines.

A technology unrelated to casino games is marketed by Phillips Electronics as “AMBILIGHT”. Ambilight is short for ambient lighting and is a feature of certain models of Phillips' televisions where, based upon video contents, separate light elements emitting colors to, for example, the wall mounting the television. It is claimed that this technology gives the viewer a larger virtual view and decreases eyestrain.

The aforementioned ambient light technology may not be suitable for a casino environment for a variety of reasons. One is that in a casino there are numerous gaming machines in close proximity or even “banked” together operating different games or, if operating the same games, are operating different display sequences since the starting of each game is under control of individual players. It can therefore be understood that the aforementioned technology would result in the games emitting different colors at different times. It is believed that bombarding players with numerous ambient light colors from nearby machines would be distracting and annoying to the players. Another reason is that for “banked” machines there may not be sufficient “canvass” around individual machines on which to project the light.

Players who regularly play gaming machines can quickly lose interest in the particular games used. Manufacturers of such gaming machines therefore seek to develop innovative game features that add interest to the games provided on such machines, or to provide new games in order to keep players amused and willing to continue playing gaming machines.

Certain disadvantages have been present in many prior slot machines. For example, limitations of prior gaming machines include an inability to captivate gamblers, poor lighting, lack of interchangeability or reconfiguration among components, and/or issues with reel movement.

Therefore, it would be desirable to provide an improved method and apparatus for stimulating a player's frequent play on a gaming machine, such as a slot machine.

It would be highly desirable to provide an improved method and apparatus for increasing the entertainment value of gaming machines.

It would also be desirable to increase the win anticipation level of the player while playing a gaming machine.

### SUMMARY OF THE INVENTION

These and other objects of the invention can be achieved by displaying at least one or more complementary colors or images in the non-game symbol areas of a gaming machine display such as in the borders, as a background, or “wallpaper” color or image. Such or more complementary colors or images can be determined based on, for example, the game symbols selected and displayed or to be displayed, either en mass or for winning outcomes or certain winning outcomes, or for certain symbols or displays.

In one aspect, the present invention provides a gaming device for use by a player comprising: a display; a wagering device for making a wager and prompting play of the gaming device; and at least one processor for controlling the display to display symbols selected from a set of game symbols to define at least a partial game outcome. The symbol set preferably has at least two color characteristics, and each of the symbols has an image characteristic. The at least one processor is configured to determine and control the display to display at least one of a complementary color and a complementary image over at least a portion of the display.

In another aspect, the present invention provides a method for providing a game display to a player, comprising:

displaying symbols selected from a set of game symbols on a display to a player to define at least a partial game outcome, said symbol set having at least two color characteristics and each of said symbols having an image characteristic;

determining at least one of a complementary color and a complementary image to be displayed over at least a portion of said display; and

displaying said at least one of said complementary color and said complementary image to the player over said at least a portion of said display at a time during which said selected symbols are displayed.

In yet another aspect, the present invention provides a method of displaying a game to a player comprising:

providing a first display area for display of game content;

predefining a plurality of symbols;

displaying several ones, but not all, of a plurality of said symbols, in said first display area;

providing a second display area separate from said first display area; and

displaying at least one of a complementary color and a complementary image in said second display area when a particular one or combination of said symbols is displayed in said first display area.

### BRIEF DESCRIPTION OF THE DRAWINGS

FIG. 1 is a front view of an exemplary gaming machine according to one embodiment of the present invention.

FIG. 2 is a front view of an exemplary gaming symbol in a coordinate game display matrix, for use in the gaming machine of FIG. 1.

FIG. 3 is a schematic block diagram of a random number generator and look up table according to one embodiment of the present invention.

FIG. 4 is an exemplary look up table associating game symbols with complementary colors.

FIG. 5 illustrates a flow diagram for a method for providing a game display to a player in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

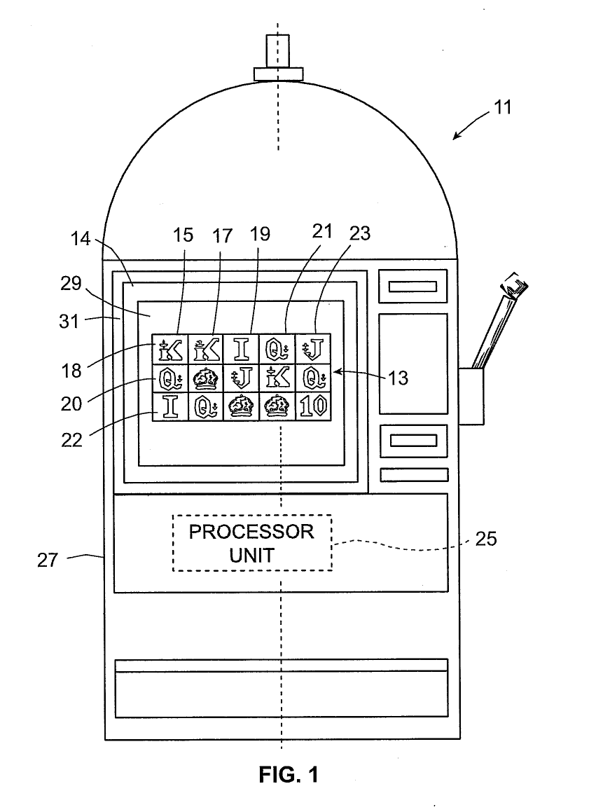

Referring to FIG. 1, a gaming device 11 is in the form of a video slot machine having a content display, generally indicated at display 13, for presenting game content to the player. Display 13 may be formed from a video display device 14, as for example, a liquid crystal display (LCD), a cathode ray tube display (CRT), a plasma display, or other type of video display, and is controlled to display five (5) simulated spinning reels 15, 17, 19, 21 and 23. Each reel visually rotates on display 13, independently of the other 4 reels, and forms a single vertical column of the content display 13.

While a multi-reel video display has been shown for the purposes of describing one embodiment of the invention it should be understood that the game could be video poker or any other forms of electronic gaming. Further, while the device 11 shown is depicted as a stand alone electronic gaming device, the various embodiments of the present invention could be implemented in PDAs, cell phones, mobile gaming, or any other gaming environment where gaming takes place using monetary based wagers, e.g. casino gaming, or for novelty gaming using promotional or valueless credits. Further, where games are connected to or interact with a large screen display, the features of the present invention may be applied to the individual gaming machines or the large display.

It will be understood that instead of providing a video display unit which displays representations of reels, actual, electro-mechanical reels may be used. Such gaming machines including actual rotatable reels are commonly termed stepper machines. For example, in an alternative embodiment, the gaming device 11 may be implemented as an electromechanical reel-based slot machine having a content display area 13 with spinning stepper reels 15, 17, 19, 21, and 23 rotating in the game display area 13. The game may have fewer or more reels as desired. The game display area 13 may be surrounded by a video display device 14, for example. Where a transmissive display is used the transmissive display may overlay the game display area 13. Video displays (e.g., LCD, CRT, plasma, etc.) and/or other illuminating or light sources (e.g., lamps, light emitting diodes (LEDs), etc.) may also be integrated with spinning reels 15, 17, 19, 21, and 23 to illuminate or animate desired display locations such as pay lines, pay combinations, winning lines, winning combinations, special symbols, etc.

Lighting may also be used to backlight symbols and/or generating a flickering or flashing effect as the electro-mechanical reels 15, 17, 19, 21, and 23 spin, for example. In certain embodiments, one or more light sources may be used with one or more filters to adjust certain characteristics of light emitted by the one or more light sources (e.g., altering lamp light to simulate natural daylight), for example.

To operate gaming device 11, the player enters a wager (money wager, wager of accumulated credits, etc.) and prompts device 11 to generate and display an outcome at the content display 13. If the outcome is a winning outcome, the player is awarded credits, coins, tokens, vouchers, etc. If the outcome is a losing outcome the player receives no award. A winning outcome may be embodied as one, two or more symbols in the display 13 and may require they be in a predetermined arrangement, e.g. on an enabled (wagered upon) pay line.

The outcome may be determined, for example, by the combination of symbols which appear in content display 13. Each of the displayed five spinning reels displays a plurality of symbols, and when stopped presents one or more symbols in the content display 13. The symbols displayed may be associated with pay lines 18, 20, 22 or may represent “scatter” wins (a predetermined number of symbols displayed anywhere in the game display 13). Five symbols may appear along each horizontal “line” or row 18, 20, 22 of content display 13. For example, the middle line 20 may be the line upon which the outcome is determined. As shown in FIG. 1, middle line 20 has the combination of five symbols “Q”, a “crown”, “J”, “K” and “Q”. The top line 18 and the bottom line 22, may also have symbols and form two other pay line combinations of five symbols, which may be used to determine wins. Thus, a three-by-five matrix defining an array symbols appears as the content display.

While the content in display 13 of FIG. 1 shows a three pay line game, it should be understood that is just an example. For example, modern games with up to fifty pay lines and games with up to 243 “ways” to win have been disclosed in U.S. Pat. No. 6,093,102 issued Jul. 25, 2000, to Bennett, the disclosure of which is hereby incorporated by reference.

The game symbols are selected and displayed from a predetermined universe of symbols as set by the game designer. These symbols may be symbols which are common to numerous games as well as symbols which are unique to the individual game and reflect the overall theme of the game. As such, the symbols can have various shapes and colors or combinations of colors. For example, a symbol may be a brown horse with a red saddle, a bald eagle having the colors of white and grey, a human figure having flesh tones and blue clothing and so forth. Thus each symbol has a shape and a color (or multi-color) characteristic. In the display of a game outcome (or partial outcome) as shown in the example of FIG. 1, there would be a display of fifteen symbols, some of which may appear only once in the display and some which may appear multiple times in the display.

In a multi-reel, video slot machine there may be more than twenty different symbols in the universe of game symbols. These symbols or symbol combinations are randomly selected by known means such as an approved random number generator (RNG) for display on the five reels.

Device 11 operates under control of a game control processor unit 25 disposed within a housing 27 of device 11. Game control processor unit 25 accounts for the wager input, randomly selects the outcome of the game and controls the display 13 to display the game symbols at display 13.

The game display 13 includes a game content area 50 where the game symbols are displayed surrounded by a border area 29 at least partially surrounding the content area 50. As shown in FIG. 1 the border area 29 of the video display 13 may completely surround the content area 50. In one embodiment, the processor unit 25 may be configured to control the display 13 to display the symbols against a background which extends into the border area 29 whereby the background may be seen behind and between the symbols. Thus the symbols are displayed against the background. The border or complementary display area 29 may be formed as a border of all or a portion of the video display device 14 (as shown in FIG. 1), e.g., on the same display as the game display area 13, or display area 29 may be a separate flat screen (not shown) which surrounds all or a portion of display device 14.

Complementary display area 29 may be controlled to display an image having characteristics including color to complement and enhance the visual aspects of the game and one or more particular outcomes. Complementary display area 29 may be controlled to generate light, and more particularly, a particular color of light, a particular brightness of light, a particular flashing pattern of light, etc.

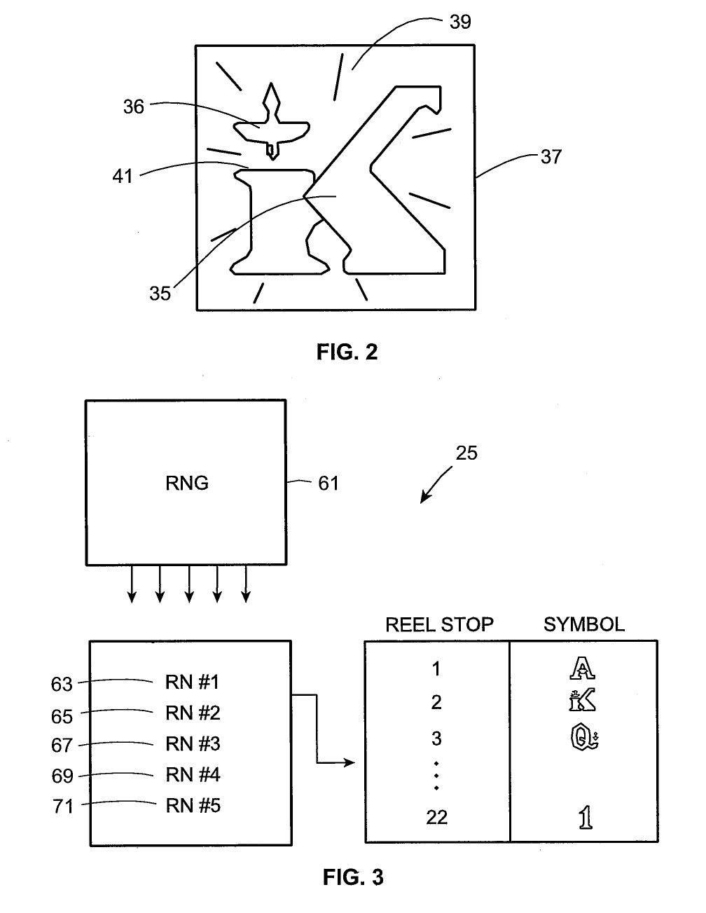

Referring now to FIG. 2, an example of a symbol 35 which may be displayed at the display 13 is shown which, for purposes of explanation, has a shape of the letter K. Symbol 35 has a color characteristic of being a shade of orange and a shape characteristic of being in the shape of a “K”. Adjacent to the “K” of the symbol 35 is a cap image 36 which may be a shade of red, and is positioned on a square shaped display 37 which is colored white to provide a white background to the orange “K”. In addition, other markings 39 such as strokes, can be colored black, and are also placed on white background display 37. Also, symbol 35 is outlined in the color black by outline marking 41.

The symbol “K” and other symbols can have different color and shape characteristics, as known in the art.

Based upon at least the color characteristic of each or a combination of symbols, there can be a complementary color and/or image displayed together with the symbol or combination of symbols. As but an example, for the “K” symbol, a pleasing complementary color may be a light blue or yellow. Such colors may be determined using a standard color wheel. Where, for example, the “K” symbol is the dominant symbol in the display (by number) or the “K” symbol forms part of a winning combination, the processor 25 can control the border 29 to turn to a blue color to complement the K symbols. This color change may be temporal with the display returning to its default color or may remain until the next spin of the game. As an additional feature, where the game has multiple paylines producing multiple symbol combinations, the border 29 may change as each winning combination is identified by the game or for only those combinations have a certain pay or triggering a certain game feature. For example, one or more symbols represent the jackpot or a trigger for a certain other feature, the processor 25 can control the display device 14 to display at the border 29 the complementary color.

The intensity (brightness) or hue of the complementary color and/or image in the border 29 may be increased in accordance with, for example, the number of “K” symbols appearing in the outcome on row 20, or outcome of the array. When three “K” symbol appears in row 20, for example, the brightness or hue of the border 29 can be of a first condition. When four “K” symbols appear in row 20, for example, the brightness or hue can be of a second condition.

Referring to FIG. 3, processor unit 25 may include a random number generator 61 which generates, for example, five (5) random numbers 63, 65, 67, 69, 71 upon activation of gaming device 11 to initiate play of a game and to develop the content display 13 (FIG. 1). Each random number determines the reel stop position of a respective display reel 15, 17, 19, 21, 23 which, in turn, determines which (and where) symbols will be displayed in the display 13 as is well known in the art.

As but an example, the processor 25 can utilize the random number(s) 63 to designate, i.e., identify, a particular symbol set to be displayed for each virtual reel 15, 17, 19, 21, 23 in the display 13 of FIG. 1. A symbol look-up map can be defined for each reel as suggested in FIG. 3. The random number dictates the set of symbols to be displayed. For example, and with reference to FIG. 1 and FIG. 3, if the random number is 3 for reel 15, the “Q” symbol would be position at row 20, the “K” symbol at row 18 and the “I” symbol on row 22. This process is also done for the remaining reels to produce the final outcome matrix of symbols. The processor unit 25 also compares the symbols displayed on the pay lines to determine winning and losing outcomes, as is also known in the art. For winning outcomes the player receives an award (or an opportunity to play a bonus game). For losing outcomes the player receives no award.

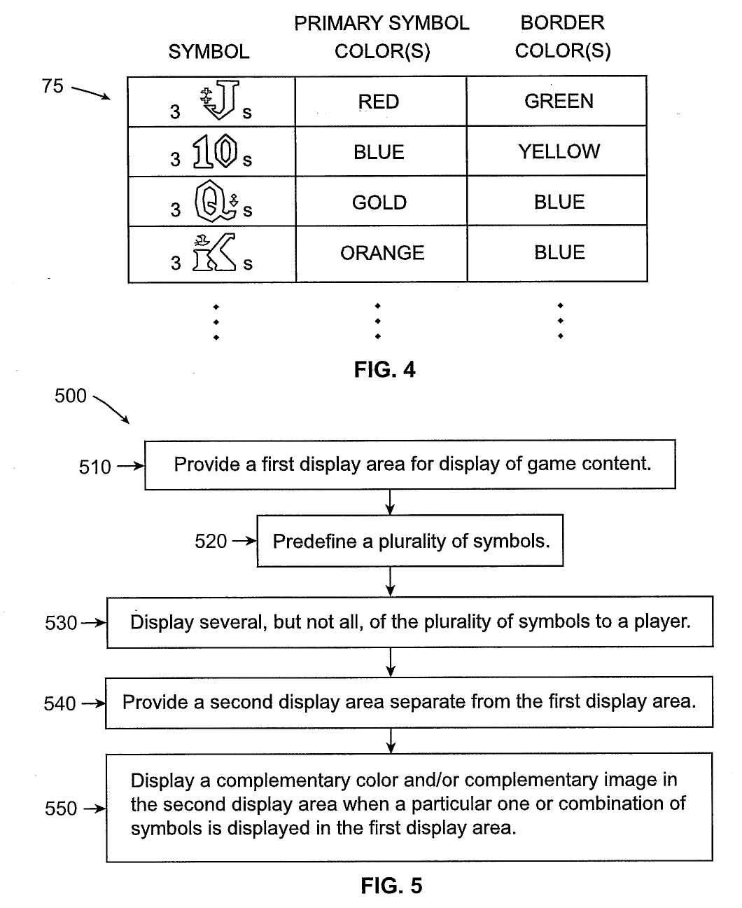

In an embodiment where the border 29 is changed based upon at least one winning outcome, FIG. 4 shows an example of a look-up table 75. Where the “J's” have primarily a red color characteristic, the border would be controlled to have a light green color. Where a winning outcome of 3 “10's” which have primarily a blue color, the background would be controlled to have light yellow color.

The term “primary symbol color” is meant a color that is associated with a particular symbol. As discussed with respect to FIG. 2, the symbol “K” 35 can be colored orange. Thus, orange is the primary symbol color of the symbol “K”. The player will associate orange with the “K” because of the “K's” visual appearance.

As will suggest itself, the symbol “K” or other symbols may have different color characteristics and the designer may decide to have other complementary colors with one or more symbols or symbol combinations. Still further, the color of the border 29 may change gradually between complementary or default colors such as, for example, gradually changing the color from the bottom of the display 18 to the top or from left to right or right to left.

As another embodiment, the color of border 29 may change based on a combination of the colors indicated by dominant symbols (symbols which play a part in a winning outcome) displayed over one or several outcomes.

As another embodiment, the color of border 29 can change when a win outcome was presented. Such a change can occur, for example, when the reels stopped, or may occur shortly before the reels stopped, e.g., one second before the reels stopped. For example, the complementary color and/or image of border 29 may persist until the next game is played, or end or fade off after two or three seconds or persist until the next winning outcome.

As a further embodiment, the border 29 may change to produce a complementary “wallpaper” of symbols or symbols and colors. For example, when the player has a winning outcome of three K's, the border 29 can change to a light blue color and have watermark images of “Ks” to highlight the win. The watermark or “phantom” images may be fixed, may move or may change in shape to, for example, complement the identification of winning outcomes.

In accordance with yet a further embodiment, only a portion of the border 29 changes such as a bottom panel, top panel, side panel, the spaces between the game symbols or a thin border “skin”.

As understood, several modifications may be made to the examples given, without departing from the spirit or scope of the invention. For example, the outcome display may be electromechanical instead of video. In addition, both displays 29 and 31 may be controlled separately to display different light characteristics, as for example, different colors of light. More than two displays may be controlled. Instead of displays adjacent to the symbol display, light characteristics could be made in the belly glass, coin tray or other locations in eye-view of the player.

The components, elements, and/or functionality of the system(s) described above may be implemented alone or in combination in various forms in hardware, firmware, and/or as a set of instructions in software, for example. Certain embodiments may be provided as a set of instructions residing on a computer-readable medium, such as a memory or hard disk, for execution on a processor-based video or electromechanical gaming machine.

FIG. 5 illustrates a flow diagram for a method 500 for providing a game display to a player in accordance with an embodiment of the present invention. At step 510, a first display area is provided for display of game content.

At step 520, a plurality of symbols are predefined.

At step 530, several ones, but not all, of a plurality of symbols are displayed to a player. For example, two like symbols are displayed to the player. As another example, several symbols may be displayed at a game time relative to initiation of a game by a player. In certain embodiments, symbols selected from a set of game symbols are displayed to a player to define at least a partial game outcome. In certain embodiments, such a symbol set has a plurality of color characteristics, and each symbol in the set has an image characteristic.

At step 540, a second display area is provided separate from the first display area.

At step 550, a complementary color and/or a complementary image are displayed in the second display area when a particular one or combination of the symbols is displayed in the first display area. In certain embodiments, the complementary color and/or complementary image may be defined prior to the step of displaying several ones of the symbols. In certain embodiments, defining includes defining the complementary color and/or complementary image based upon the color characteristics of at least one of the several symbols.

In certain embodiments, the display of the complementary color and/or complementary image occurs for a predetermined period of time, at least a portion of which occurs when a particular one or combination of symbols is displayed in the game display area. The predetermined period of time may be shorter than the time during which a particular one or combination of symbols is displayed in the game display area. In certain embodiments, the portion of time is equal to the entire portion of time during which the particular one or combination of symbols is displayed in the first display area.

In certain embodiments, the second display area at least partially forms a border around the first display area, and the complementary color and/or complementary image is displayed in the border. In certain embodiments, the second display area forms a background for the first display area, and the background is displayed in the complementary color and/or complementary image with respect to selected symbols. In certain embodiments, the complementary color and/or complementary image area positioned proximate to the display of the selected symbols, for example.

One or more of the steps of the method 500 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

The complementary display area 29 may also be controlled to display color (and graphics) in association with other game displays such as secondary game displays which may present outcomes in other than matrix-form. For example, if a player is present with a secondary game involving choices between a plurality of icons, the complementary display 29 may display features complementary to the icon selected by the player.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Several embodiments are described above with reference to drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any machine-readable media for accomplishing its operations. As noted above, the embodiments of the present invention may be implemented using an existing processor, or by a special purpose processor incorporated for this or another purpose or by a hardwired system.

As noted above, certain embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other gaming machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the present invention may be practiced in a networked environment using logical connections to one or more gaming devices having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of gaming system configurations, including slot machines, video gaming machines, personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated.

Those skilled in the art will appreciate that the embodiments disclosed herein may be applied to the formation of a variety of gaming systems. Certain features of the embodiments of the claimed subject matter have been illustrated as described herein; however, many modifications, substitutions, changes and equivalents will now occur to those skilled in the art. Additionally, while several functional blocks and relations between them have been described in detail, it is contemplated by those of skill in the art that several of the operations may be performed without the use of the others, or additional functions or relationships between functions may be established and still be in accordance with the claimed subject matter. It is, therefore, to be understood that the appended claims are intended to cover all such modifications and changes as fall within the true spirit of the embodiments of the claimed subject matter.

While certain embodiments of the present invention have been described, it should be understood that these embodiments are subject to many modifications and changes without departing from the spirit and scope of the appended claims. For example, it will be understood that the invention disclosed and defined in this specification extends to all alternative combinations of two or more of the individual features mentioned or evident from the text or drawings. All of these different combinations constitute various alternative aspects of the invention. It will also be understood that the term “comprises” (or its grammatical variants) as used in this specification is equivalent to the term “includes” and should not be taken as excluding the presence of other elements or features.

What is claimed is:

1. A gaming device for use by a player comprising:
a display;
a wagering device for making a wager and prompting play of the gaming device; and
at least one processor for controlling said display to display symbols selected from a set of game symbols to define at least a partial game outcome, said symbol set having at least two color characteristics and each of said symbols having an image characteristic, wherein
said at least one processor is configured to determine and control said display to display at least one of a complementary color and a complementary image over at least a portion of said display.

2. The gaming device of claim 1, wherein said display has a game content viewing area at least partially surrounded by a border, and said at least one processor is configured to control said display to display in said border said at least one of said complementary color and said complementary image.

3. The gaming device of claim 1, wherein said at least one processor is configured to control said display to display the selected symbols on a background, and to display said background in said at least one of said complementary color and said complementary image.

4. The gaming device of claim 1, wherein said at least one processor is configured to determine said at least one of said complementary color and said complementary image based upon the color characteristics of at least one of said selected symbols.

5. The gaming device of claim 4, wherein the display of said selected symbols defines at least one winning outcome, and said at least one processor is configured to determine said at least one of said complementary color and said complementary image based upon the color characteristics of at least one of said selected symbols of the winning outcome.

6. The gaming device of claim 1, wherein said game outcome is a winning outcome.

7. The gaming device of claim 1, wherein said at least one of said complementary color and said complementary image is positioned proximate to the display of said selected symbols.

8. The gaming device of claim 1, wherein said display comprises a video display area displaying a video representation of at least one rotatable reel.

9. The gaming device of claim 1, wherein said display comprises a display area including at least one electromechanical rotatable reel.

10. The gaming device of claim 1, wherein said processor controls said display to create a flashing effect when observed by a player.

11. The gaming device of claim 1, wherein said display comprise at least one rotatable reel including a plurality of symbols, and wherein said processor controls said display to illuminate at least one but less than all symbols on said at least one rotatable reel.

12. The gaming device of claim 1, wherein said display is controlled by said processor to illuminate an area of said display with colored light of a different color from normal display illumination for game play in response to an event occurring during operation of the gaming device.

13. The gaming device of claim 1, wherein said display comprise at least one rotatable reel including a plurality of symbols, and wherein said display is controlled by said processor to illuminate a betting combination on said at least one rotatable reel.

14. A method for providing a game display to a player, comprising:
displaying symbols selected from a set of game symbols on a display to a player to define at least a partial game outcome, said symbol set having at least two color characteristics and each of said symbols having an image characteristic;
determining at least one of a complementary color and a complementary image to be displayed over at least a portion of said display; and
displaying said at least one of said complementary color and said complementary image to the player over said at least a portion of said display at a time during which said selected symbols are displayed.

15. The method of claim 14, wherein said display has a game content viewing area at least partially surrounded by a border, and said at least one of said complementary color and said complementary image is displayed in said border.

16. The method of claim 14, wherein the selected symbols are displayed on a background, and said background is displayed in said at least one of said complementary color and said complementary image.

17. The method of claim 14, wherein said at least one of said complementary color and said complementary image is determined based upon the color characteristics of at least one of said selected symbols.

18. The method of claim 14, wherein the display of said selected symbols defines at least one winning outcome, and said at least one of said complementary color and said complementary image is determined based upon the color characteristics of at least one of the selected symbols of the winning outcome.

19. The method of claim 14, wherein said at least one of said complementary color and said complementary image is displayed for a predetermined length of time.

20. The method of claim 14, wherein said at least one of said complementary color and said complementary image is positioned proximate to the display of said selected symbols.

21. A method of displaying a game to a player comprising:
providing a first display area for display of game content;
predefining a plurality of symbols;
displaying several ones, but not all, of a plurality of said symbols, in said first display area;
providing a second display area separate from said first display area; and
displaying at least one of a complementary color and a complementary image in said second display area when a particular one or combination of said symbols is displayed in said first display area.

22. The method of claim 21, further comprising defining said at least one of said complementary color and said complementary image prior to said step of displaying said several ones of said symbols.

23. The method of claim 22, wherein said step of defining includes defining said at least one of said complementary color and said complementary image based upon the color characteristics of at least one of said several ones of said symbols.

24. The method of claim 21, wherein said step of displaying said at least one of said complementary color and said complementary image occurs for a predetermined period of time, at least a portion of which occurs when a particular one or combination of said symbols is displayed in said game display area.

25. The method of claim 24, wherein said predetermined period of time is shorter than the time during which a particular one or combination of said symbols is displayed in said game display area.

26. The method of claim 24, wherein said portion is equal to the entire portion of time during which said particular one or combination of said symbols is displayed in said first display area.
